(19) United States
(12) Patent Application Publication
(10) Pub. No.: US 2018/0033513 A1
(43) Pub. Date: Feb. 1, 2018

(54) CONSTRUCTIONS OF X-RAY LENSES FOR CONVERGING X-RAYS

(71) Applicant: Convergent R.N.R Ltd., Tirat Carmel (IL)

(72) Inventors: Aharon BAR-DAVID, Nesher (IL); Miri MARKOVICH, Haifa (IL); Avigail KELLER, Haifa (IL); Zeev BURSHTEIN, Nes Ziona (IL); Zeev HAREL, Kfar Saba (IL)

(73) Assignee: Convergent R.N.R Ltd., Tirat Carmel (IL)

(21) Appl. No.: 15/639,315

(22) Filed: Jun. 30, 2017

Related U.S. Application Data
(63) Continuation-in-part of application No. PCT/IL2015/051265, filed on Dec. 29, 2015.
(60) Provisional application No. 62/097,628, filed on Dec. 30, 2014.

(51) Int. Cl. G21K 1/06

(52) U.S. Cl. CPC G21K 1/067

(57) ABSTRACT

An X-ray system for providing a converging X-rays comprising: (a) an X-ray source having an optical axis thereof; (b) an X-ray lens arrangement comprising at least one first ring having a first Bragg reflecting surface formed by a plurality of tiles made from single crystal. At least one ring is provided with at least one second ring mounted adjacently thereto along said optical axis in a coaxial manner; said second ring has a second Bragg reflecting surface reflecting surface thereof.

### CROSS-REFERENCE TO RELATED APPLICATIONS

This application is a continuation-in-part application of international application PCT/RU2015/051265 filed on Dec. 29, 2015 and claiming priority from U.S. provisional application 62/097,628 filed on Dec. 30, 2014.

### FIELD OF THE INVENTION

Converging X-rays are used in two main fields: Radiotherapy/Radio-surgery and imaging, but one can find other uses as well.

The means of converging X-rays are described below as well as the structure of an X-ray converging lens. The main idea of this invention is to describe the additional techniques by which such a lens can be manifested in an easier way with better control of the treated volume without harming the surrounding area.

### BACKGROUND OF THE INVENTION

Ionizing radiation equipment for the use of Radiotherapy and Radio surgery of today are mainly the Linear accelerator (LINAC), proton therapy and radioactive source devices like Gama knife. These devices are being used mainly to cure cancer. Today's existing X-ray equipment use X-ray sources that generate diverging beams. In cases where a narrow beam is needed, the techniques to narrow the beam are done by means of collimation that blocks the beam to create the desired shape. As a result only a thin portion of the beam is used with a small fraction of the generated intensity, which becomes weaker and weaker as the beam progresses. That is why to produce an effective treatment one has to rotate these instruments from many angles around the body.

Converging X-ray device had been suggested and mentioned in patent documents US2013/0170625, U.S. Pat. No. 6,389,100, U.S. Pat. No. 6,625,250, U.S. Pat. No. 6,606,371, U.S. Pat. No. 6,968,035. These documents show various types of lenses for the converging of X-rays. PCT publication WO2014045273 also shows a way to control the focal volume. Converging X-rays for medical use was mentioned in patent documents U.S. Pat. No. 7,070,327, U.S. Pat. No. 7,468,516 and US 2005/0175148.

The present invention shows an additional way to manufacture a converging X-Rays lens that converges X-Rays to a point or to a volume, where the source can be a point source or an extended source. The construction presented here utilizes new methods and principles that have advantages in improved methods of controlling the beam shape, size and uniformity, the beam quality, the focal region shape and size and the simplicity of manufacturing.

There are several methods known and being utilized using the Bragg law mentioned like those mentioned for example in patent documents US 2013/0170625, U.S. Pat. No. 6,625,250, U.S. Pat. No. 6,968,035 and others. The known methods are based on the Johansson and Johan principle where the reflecting units are assembled on Roland circles shape construction.

Pre-Grant publication US2013/0170625 also mentions the possibility of implementing a curved crystal surface by the use of tiles. They show tiling on a curved surface of a single ring structure containing tiny tile elements having curved surface of negative radius each.

The present invention alters these ideas for the controlling of the volume of treatment in shape and size with using a new simple easy manufacturing way of using flat tiles arranged in a way that allow the possible deviating from the Roland shape and Johansson and Johann theory due to additional features and considerations for control of the volume and shape of the focal region and to optimize the energy collection efficiency from the source.

### SUMMARY OF THE INVENTION

It is hence one object of the invention to disclose An X-ray system arranged for converging X-rays comprising an X-ray source and an X-ray lens system consisting of reflecting surfaces assembled from single crystal tiles arranged in longitudinal cross-section tiling by assembling at least 2 rings in an extended form of coaxial structure.

Another object of the invention to disclose An X-ray system arranged for converging X-rays comprising an X-ray source and an X-ray lens system consisting of reflecting surfaces assembled from single crystal tiles arranged in such a way that allows the deviation of the structure from the Roland curve and the Johann and Johansson theory. Another object of the invention is to disclose the said X-ray system wherein the lens system consists of single crystal tiles whose tile reflecting surface may be adjusted individually on each tile and/or a group of tiles.

Another object of the invention is to disclose the said X-ray system wherein the lens system consists of planar single crystal tiles whose size play a role in the controlling of the irradiated target.

Another object of the invention is to disclose the said X-ray system wherein the lens system consists of part of rings, complete rings, conical rings, barrel shaped rings and any combination thereof.

Another object of the invention is to disclose the said X-ray system wherein the lens system comprises concentric reflecting rings, coaxial reflecting rings, non-concentric reflecting rings, non-coaxial reflecting rings, and any combination thereof.

Another object of the invention is to disclose the said X-ray system wherein the lens system comprises symmetrical structures, asymmetrical structures and any combination thereof. By symmetrical structure we mean the longitudinal midpoints of the rings are half way between the source and the focal region,

Another object of the invention is to disclose the said X-ray system wherein the lens system comprises reflecting rings having tilted longitudinal cross-section, non-tilted longitudinal cross-section and any combination thereof.

Another object of the invention is to disclose the said X-ray system wherein the lens system comprises reflecting rings having off-cut angle between the reflecting surface and the desired crystallographic planes, zero degrees and/or different than zero degrees and any combination thereof.

Another object of the invention is to disclose the said X-ray system wherein the lens system comprises reflecting rings whose longitudinal midpoints are located on Roland circles with the appropriate tilt and off-cut angle in each ring to match the Johansson theory or Johan theory, where the rings are mounted in an extended form of coaxial ring

Another object of the invention is to disclose the said X-ray system wherein the lens system comprises reflecting rings where some of the rings or all may be arranged so that their longitudinal midpoints deviate from Roland circles and/or tile tilts deviate from the Johansson theory and/or Johan theory and/or off-cut angle deviates from the Johansson theory and/or Johan theory and any combination thereof.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a 3 dimensional schematic diagram of an X-ray lens with an example of concentric rings construction.

FIG. 2a is a 3 dimensional schematic diagram showing several rings in a non concentric arranged in a coaxial structure.

FIG. 2b is a 3 dimensional schematic diagram showing several rings in a non concentric and non coaxial structure.

FIG. 3 shows a 3 dimensional schematic structure of rings constructed from small single crystal tiles with a magnified description of a single tile.

FIG. 4a shows a schematic diagram of the cross-section of a general single crystal tile with the internal structure and orientation of the desired crystallographic planes relative to the tile reflecting surface, making an angle between the crystallographic planes and the reflecting surface of the tile.

FIG. 4b shows a schematic diagram of the special case of the cross-section of a single crystal tile where the internal orientation of the desired crystallographic planes are parallel to the tile reflecting surface.

FIG. 4c shows a schematic diagram demonstrating a tilt angle of a tile forming rings whose longitudinal cross-section reflecting surface forms a tilted angle relative to the optical axis, and the crystallographic planes form an angle that may be different than the first mentioned, relative to the optical axis and/or the reflecting surface.

FIG. 5a shows a 3D description of the extensions of a single ring.

FIG. 5b shows a 3D description of several rings with their extensions that forms a complete extended structure.

FIG. 6a shows a schematic diagram of a two dimensional longitudinal cut of tiles from 4 rings, where 3 rings are assembled in an extended structure. The example shows the rings to be located on an approximate structure of Roland circles whose reflecting surfaces are grinded and polished according to the Johann or Johansson theory—making a relatively small focal region.

FIG. 6b shows a schematic diagram of a two dimensional longitudinal cut of tiles from 4 rings, where 3 rings are assembled in an extended structure. The example shows the rings to be located on a structure deviating from Roland circles and or the Johann or Johansson theory—making a relatively large focal region.

FIG. 7a shows a 3D drawing of an adjusting system for individual tile to be mounted to a ring with holes and screw assembly to hold individual tiles glued to holder with 3 threads for the adjustment of individual tiles to see the source in Bragg angle and aim the reflection to the desired location.

FIG. 7b shows a 3D drawing a ring fully populated with tiles that are adjustable individually by 3 screws each tile.

FIG. 7c shows a 3D drawing of 2 magnified metal tile holders with the 3 screw threads each for the adjustment of the tile in combination of several adjustment axis. Two are shown to explain how adjacent tiles can be mounted with no spacing between them.

FIG. 8a shows a system structure of exact theoretical principle.

FIG. 8b shows the closest implementation of the theory with tiles and extensions—the structure of the tiles with respect to their crystallographic planes.

FIG. 9a shows some results with some types of disadvantages of the closest implementation mentioned in FIG. 8

FIG. 9b shows an example of different use of tiled extensions with a sample of deviation from the theory.

FIG. 10 shows the result with the reflected radiations of an example of deviated structure of extensions.

FIG. 11 shows the result of a deviated structure of non coaxial type. The results show the stretching of the targeted volume as an example of a stretched type of tumor.

### DETAILED DESCRIPTION OF THE PREFERRED EMBODIMENTS

The following description is provided, alongside all chapters of the present invention, so as to enable any person skilled in the art to make use of the said invention, and sets forth the best modes contemplated by the inventor of carrying out this invention. Various modifications, however, are adapted to remain apparent to those skilled in the art, since the generic principles of the present invention have been defined specifically to provide a control to the volume and shape of an X-ray system arranged for converging X-rays to a focal region.

The term “symmetric structure” refers to a ring whose rotational center is on the optical axis and whose longitudinal midpoint is half way from the source to the focal region.

The term “longitudinal midpoint” refers to the longitudinal middle point of a tile and/or a ring.

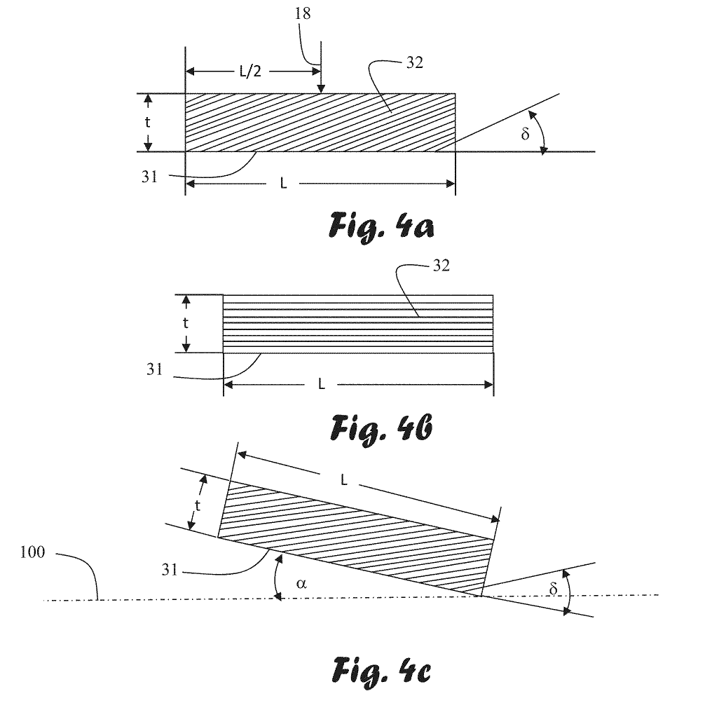

The term “off-cut angle” refers to the angle between the crystal reflecting surface (31) and the desired crystallographic plane (32)—see δ in FIG. 4.

The term “concentric” refers to rings that are located inside one another with a common center.

The term “coaxial” refers to rings that share a common axis but not necessarily located inside one another.

The term “tilt angle” refers to the angle between the reflecting surface (31) and the optical axis (100)—see α in FIG. 4c.

The term “extensions” refer to individual rings that are part of an extended structure.

A basic structure of a lens consists of a set of concentric rings comprising crystal tiles of various different crystallographic planes. An extension relates to another ring in a sense of extending it. Extending a specific ring originally is done with the use of a reflecting material that is similar to the original ring with a slight change, and mounting it coaxially on the same axis further away pending the first ring. This slight change of the reflecting material is due to a slight difference in the Bragg angle because of the different distance to the source. Usually it is the same material with the same crystallographic plane having its reflecting surface cut with a different off-cut angle and mounted at a different tilt, thus, forming the extension ring to have a conical shape.

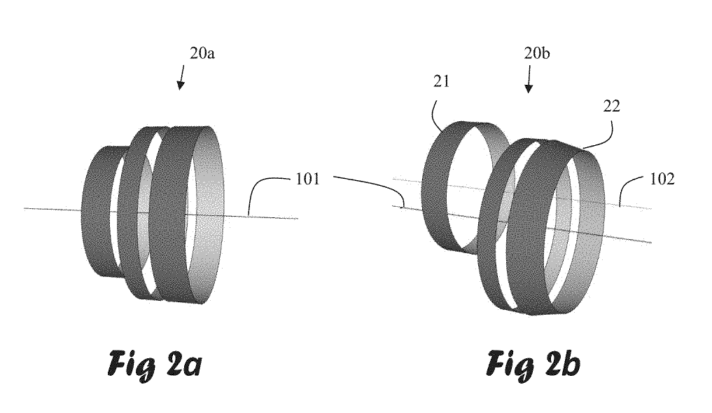

The term “extended structure” refer to a basic structure (concentric) where at least one of the rings has at least one extension assembled in a coaxial structure pending it as explained above (mainly as in FIG. 2a) to provide a form of longitudinal tiling of rings.

This invention also allows a deliberate calculated deviation from the exact theory i.e. form the Rowland circle and from the exact off-cut angle and exact tilt angle in order to control the radiated volume and shape.

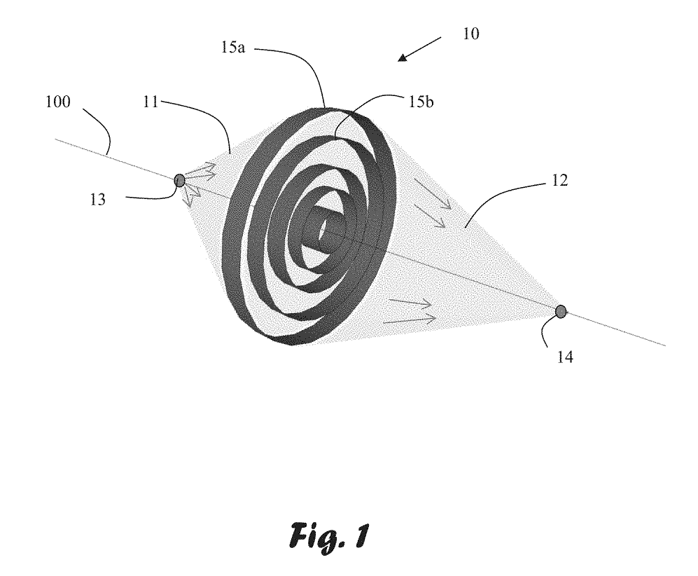

Reference is now made to FIG. 1, schematically illustrating a lens system with an example of a structure of concentric rings. An X-ray source (13) emits diverging X-rays (11) that enters the lens (10) made of concentric rings (Numbered examples are the outer rings 15a and 15b). The rings reflect X-Rays in a converging manner (12) to a focal location (14).

Reference is now made to FIGS. 2a and 2b. The lens might be made from rings having other structures. FIG. 2a shows rings assembled in a coaxial structure (20a) relative to their rotational axis (101). FIG. 2b shows example of a structure of rings (20b) assembled in a non-coaxial and non-concentric structure. Ring 21 is located in a non-coaxial manner whose rotational axis (102) does not coincide with the rotational axis of the other rings (101). Ring (22) is an example of a ring whose reflecting surface longitudinal profile is tilted relative to its rotational axis (101). In this example the ring (22) surface forms a conical structure. All rotational axes might be parallel and/or coincide or not parallel and/or not coincide to the optical axis (100).

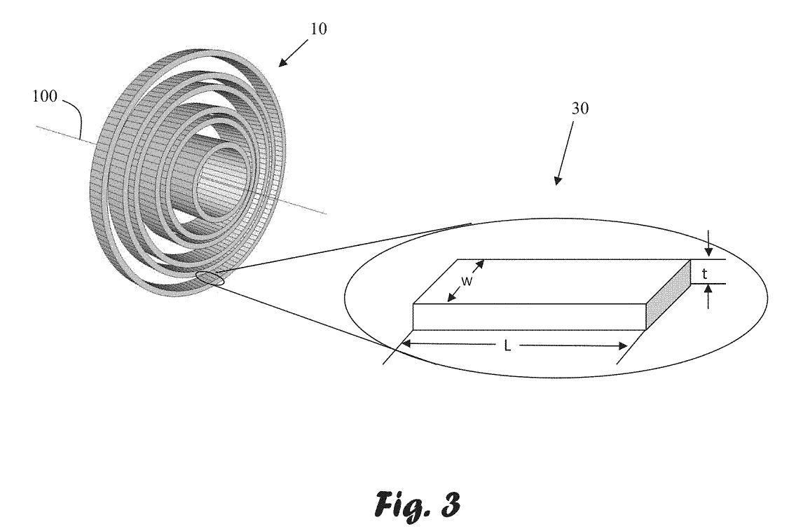

Reference is now made to FIG. 3, schematically illustrating a lens system (10) whose rings are made of tiles. A magnified illustration of a tile (30) is shown as well. L is the general longitudinal dimension that might be parallel to the optical axis (100), t is the tile thickness and w is the tile width whose direction is generally transversal to the optical axis (100).

Reference is now made to FIG. 4. FIG. 4-a schematically illustrates a longitudinal cross section along the L direction of a single tile. Generally, the direction of the cross section of the desired crystallographic planes (32) forms an angle δ with the reflecting surface of the tile (31). The longitudinal midpoint (18) of a tile is located at the longitudinal middle (L/2) of the tile.

FIG. 4-b illustrates the special case where the desired crystallographic planes are parallel to the reflecting surface of the tile (δ=0). FIG. 4-c shows a tilted tile that forms a tilted longitudinal ring profile like the one mentioned in FIG. 2b (Ring 22) for example. The tilt angle is α in the figure relative to the optical axis (100).

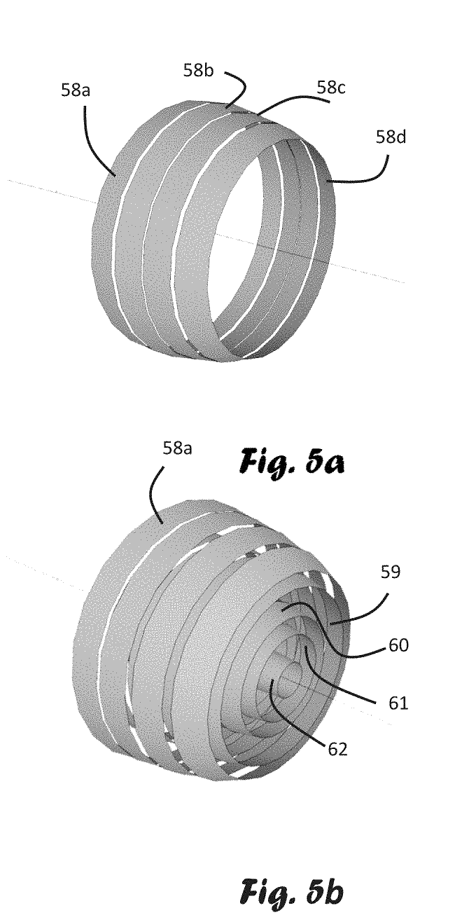

Reference is now made to FIG. 5a schematically illustrating a diagram of a 3dimesional structure of a single ring with its extensions. The first ring 58a acting as the first extension with the following extensions 58b, 58c and 58d. They are all the extensions that can be made, for example, from the same crystallographic planes having different radii, different tilt angle and different off-cut angle. The starting point of the design is around the Rowland circle with the matched crystallographic plane adjusting the tilt and off-cut around according to the Johann and Johansson theory. Further consideration is that in this design one can deviate from the Rowland radius, tilt and off-cut angle to aim to a treated volume with a controlled shape and size. These means are an additional different means described in other projects of converging beams.

Reference is now made to FIG. 5b schematically illustrating a diagram of a 3dimesional structure having additional multi ring construction where the structures 59, 60 61 and 62 form a concentric structure of multi rings, each having its own extensions.

The purpose of this structure is to aim the reflection from each extension to the neighborhood of the volume of interest. The deviation from Rowland radius, tilt and off-cut determines the size and shape of the neighborhood, thus, influence the size and shape of the irradiated volume.

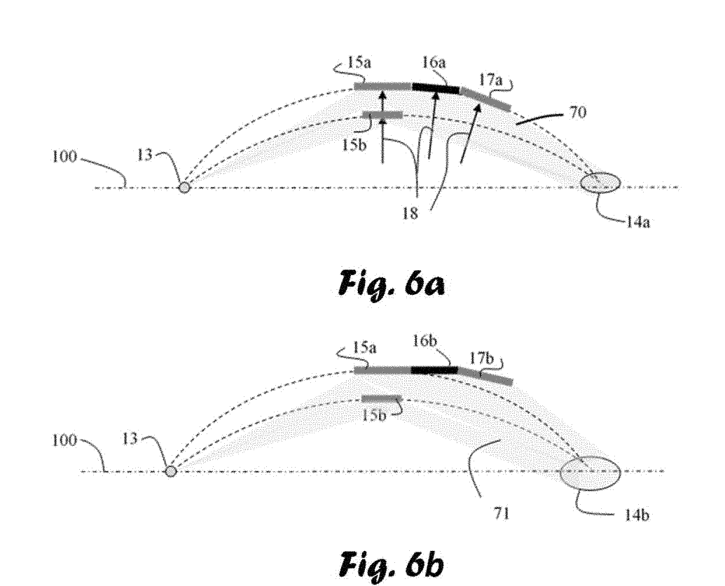

Reference is now made to FIG. 6a schematically illustrating a diagram of a two-dimensional longitudinal cut of tiles of an example having 4 rings located on an approximate structure of Rowland circles. Tiles 15a and 15b are concentric in a symmetric structure with longitudinal midpoint (18) half way between the source (13) and the focal region (14a). Tiles 15a, 16a and 17a are coaxial in this example and form a set of extensions. This configuration is an example of a lens configured to form the smallest focal region possible with the particular tiles. The outgoing reflected beam (70) from all rings is compacted together at the focal region (14a). This is according to the Johansson and Johann theory. Only the sizes of the tile are the main cause of the broadening of the target volume. In order to have the smallest focal region possible the rings have to be assembled to form structures where the longitudinal midpoints are located on the appropriate Roland circles. Additionally, the tiles reflecting surface are tiled in an angle α so as to be tangent to the Roland circle at their longitudinal midpoint and their off-cut angle δ is obtained by grinding the single crystal tiles according to the Johansson or Johann theory calculated at the longitudinal midpoints (18) locations of the tiles on the Roland circle. The midpoints (18) of tiles 16a and 17a in this example are located at a different distance to the source (13) than the distance to the targeted location (14a), in this example closer to the target (14a). However, it is possible to locate them closer to the source (13).

Reference is now made to FIG. 6b schematically illustrating a diagram of a longitudinal cut of tiles of an example having 4 rings made of tiles, where the structure of tiles are deviated from the Roland circles structures and the Johansson and Johann theory. Tiles may possess only an off-cut angle and not be tilted. As an example, for this, in FIG. 6b, the ring 16b is drawn parallel to the optical axis (100) as an extension to ring 15a (originally parallel), and the only difference between them is the off-cut angle δ which is 0 in 15a and different from 0 in 16b. Tiles may be only tilted with no off-cut angle. Longitudinal midpoints of the tiles may be located at different radii than those related to the Roland circles. The deviation of the extended structure spreads the reflected beam (71) so the volume of the radiated targets (14b) becomes larger.

Any combination of radii, tilt angles, off-cut angles may be employed according to the consideration described below.

The location of the tiles, their dimensions (length, width and thickness) their tilt and/or off-cut angles are designed to control the following:
1) The size and shape of the focal region.
2) Avoiding radiation blocking amongst the rings.
3) Beam radiation cross-section fill-up.
4) Uniformity considerations and
5) Simplicity of manufacturing.

Thus may deviate from the Roland circle structure and the Johansson and Johan theory. Tile sizes play a role in the design as well—they also controls the energy spectral width and values on the spectrum emitted by the source, for example at the neighborhood of the Kα location of a tungsten spectrum one may control the spectral width to determine whether to include Kα1 and Kα2 or even Kβ characteristic radiation or not, thus controlling beam quality.

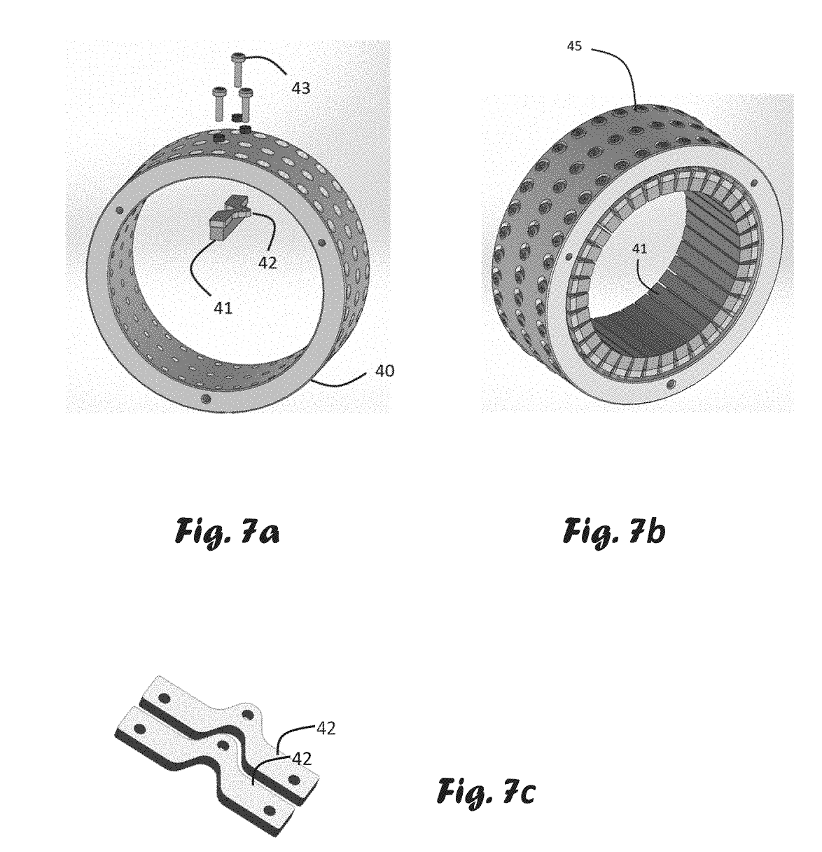

Reference is now made to FIG. 7a schematically illustrating the adjustment system of individual tiles (41). The tile (41) is to be glued on a small metal holder (42) that has 3 screw threads. Combination of small turnings of the 3 screws enable small rotations and movement of the tiles along several axis to adjust the correct angle that the source is seen by the tiles along with the reflection direction towards the desired location. The holder (42) is mounted to the ring (40) via holes through the ring body. Small springs are holding them in place.

Reference is now made to FIG. 7b schematically illustrating a complete ring (45) fully populated with tiles. The screws heads are seen on the outer surface of the ring. They allow the adjustment of each tile individually.

Reference is now made to FIG. 7c schematically illustrating a magnified picture of a pair of tile holders. To achieve the possibility to have small adjustments around and along several axes by combination of 3 screws adjustments, the middle thread must be outside the line connecting the 2 end threads near the edges of the holder. By turning the 2 end screws the tile receives a pitching movement. The 3^{rd} middle screw gives the tile a rolling movement. Turning all screws gives the tile an up and down movement as to adjust the radial distance to the ring center. Applying a combination of more than one screw adds up additional movements for example making the tile face somewhat sideways similar to a yaw adjustment or a sideways correction. Still it is possible to mount the holders adjacent to each other. To illustrate this possibility 2 adjacent holders are shown mounted next to each other.

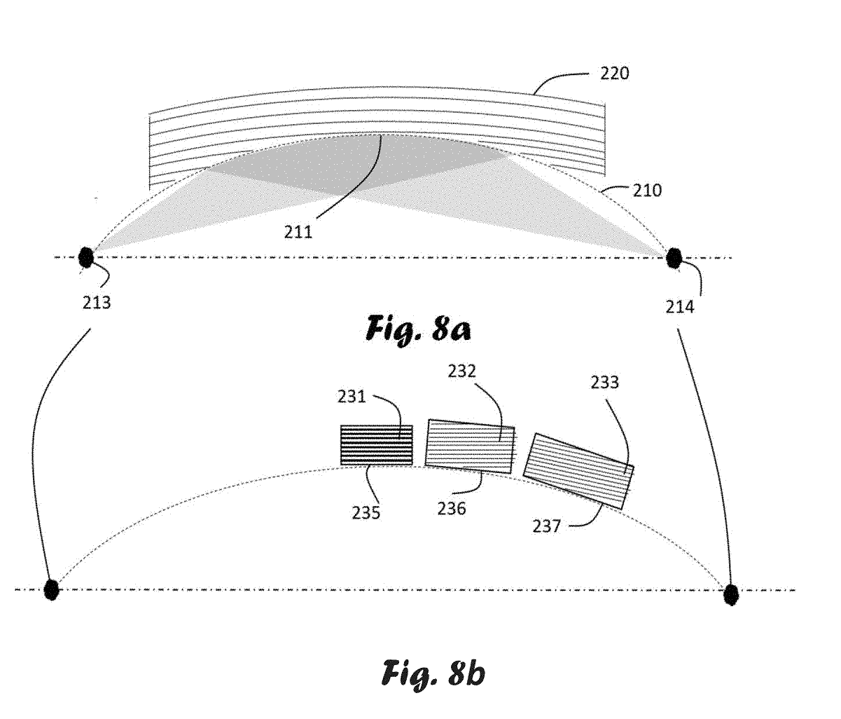

Reference is now made to FIG. 8 schematically illustrating the theoretical basis on which the invention allows also to deviate from.

FIG. 8a shows how an exact system should be built in principle: the source 213 is a small dimension type (near a point source in theory) and the target 214 will be manifested as a small theoretical volume. The reflecting surface 211 is a curved surface with the shape having Rowland radius. The crystal which is a large bent crystal has its crystallographic planes bent to twice the Rowland radius (R)−2R. Thus, the crystal planes are bent to 2R and the reflecting surface is therefore grinded to a form of one R. This is a theoretical exact geometry to focus X-rays with a Bragg principle.

However, the implementation of such a structure has its technical difficulties, and also there are cases where one desires to have a somewhat larger target volume rather than a small one.

In order to achieve that tiles are being used in two major ways:

1) A tiled ring—the ring has tiles located transversally on the circumference of the ring

2) One can tile the longitudinal part of the structure by the use of extension rings mounted coaxially with the possibility to deviate from the coaxial assembly. This is the main novelty of this invention. The starting principle is shown in FIG. 8b.

FIG. 8a shows the implementation of a structure to be as close as possible to the theory. In FIG. 8b one can see an example of 3 fold longitudinal tiling implemented with 3 extetension rings. The tiles shoe part of the longitudinal cross-section of an extension ring.

Since the reflecting surface has a curvature of R and the crystallographic planes have a curvature of 2R each longitudinal ring must employ crystals with different off-cut angle. Their reflecting surface must be tangent to R and the crystallographic planes must be tangent to 2R. Thus, in the example of FIG. 8b the tile with crystallographic plane 231 has zero angle with its reflecting surface 235. The planes 232 have an angle with their reflecting surface 236 and the planes 233 have a different angle with the reflecting surface 237. Additionally, their tilt angles are also different. Thus, the rings closer to the target have a conical shape with larger cone angle. This implementation is the closest to the theory as possible with the use of tiles and extensions.

However, the intention of this invention is also to radiate larger volumes, make construction easier and simpler and to control the shape of the volume with the use of new techniques.

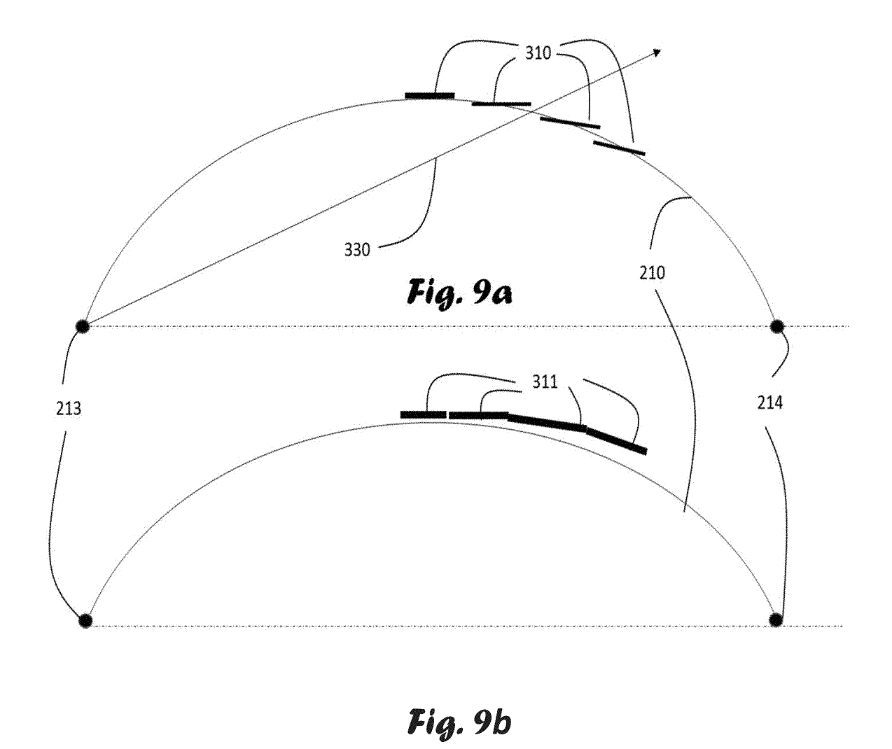

One example is shown in FIG. 9. One possible technique is to avoid different off-cut angles when manufacturing the tiles. A simple choice is choose off-cut 0.

Reference is now made to FIG. 9a showing the use of 0 off-cut tiles (310). The location of the midpoint of the tiles are the Rowland circle (210), but since the tiles have off-cut 0 they have to be oriented to be tangent to twice this radius—namely 2R. So they lay on the location of Rowland but not tangent to it because they are tangent to 2R. This structure forms a dandruff-like surface with opening so not all the radiation is captured and some rays (330) might escape.

Reference is now made to FIG. 9b showing a different example of the possibility of deviating from the theory. One might like to capture all the radiation in a certain solid angle. The idea is to disregard the Rowland circle (210) but not to go too far from it. The idea is to take 0 off-cut angle tiles and to arrange them so the extensions touch each other back to front (311) closing all spaces not allowing any ray to sneak out. The position is now determined not on the Rowland envelope but from placing the tiles front to back as connecting the adjacent rings to each other. According to this position the tilt is adjusted to the Bragg angle as seen in the new position. Thus the reflection deviates from the target direction to enlarge and change the target size and shape. The tilt of the tiles i.e. the cone angle of the extension ring is now different from the theory. The price for this is that the focusing is not exact. Thus, the radiated volume is larger. In some cases, this is acceptable and even desired. Another deviation from the Rowland envelope is possible by direct calculation of the change in the direction of the reflected beam according to the desired deviation from the focal point to enlarge the focal size and shape. This can be done for example by changing the location and angle of the added ring center axis relative to the optical axis.

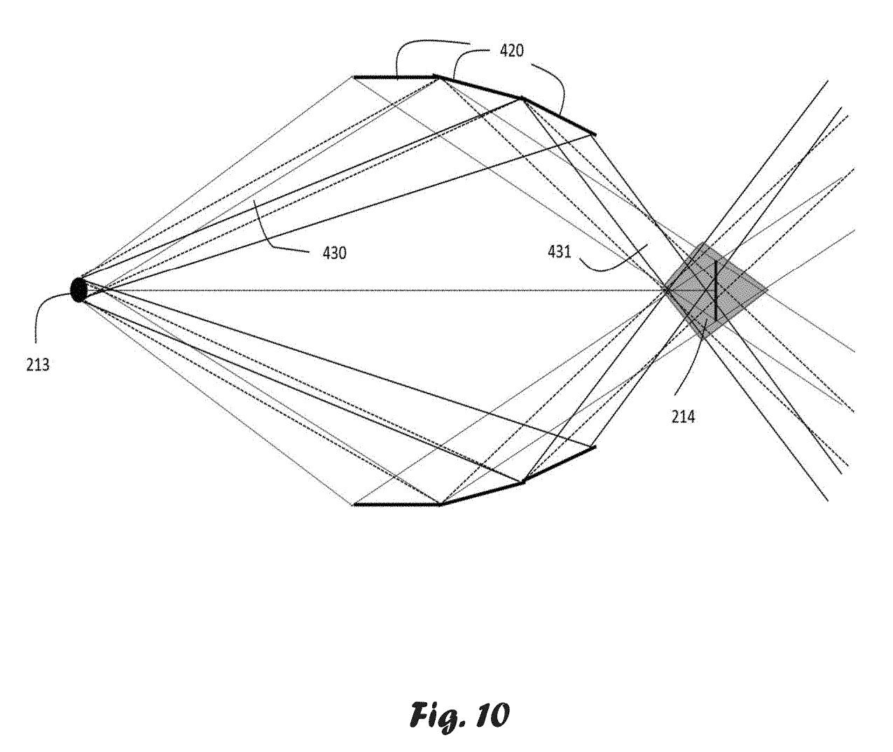

Reference is now made to FIG. 10. Showing the results of the previous examples back to front connection The tiles are located somewhat away from the Rowland location thus the incoming rays (430) that collect the rays from the source (213) at Bragg angle are reflected (431) in the neighborhood of the theoretical focal region (214) making 214 larger (as marked in the figure).

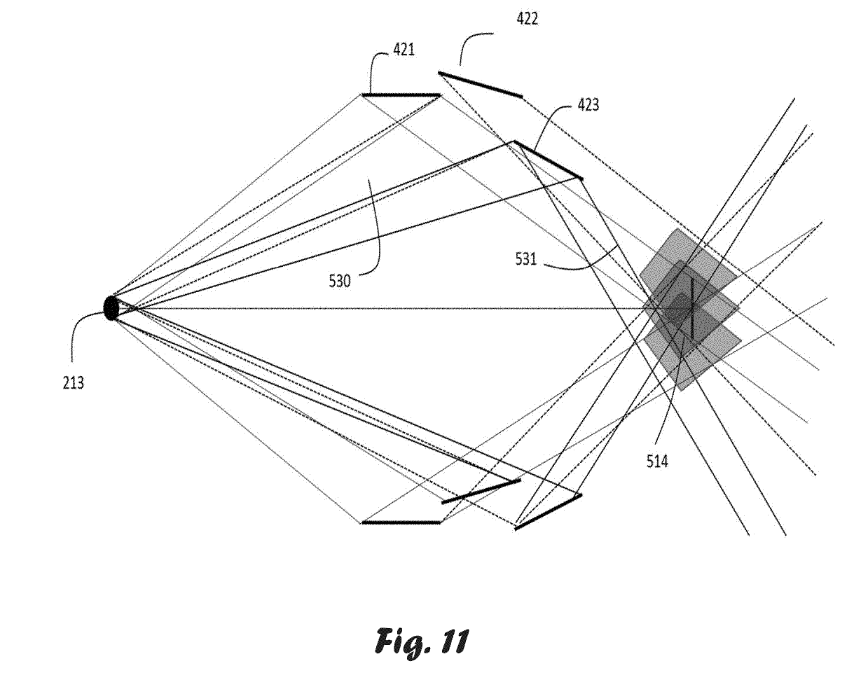

Reference is now made to FIG. 11. Showing the results of a different deviation. FIG. 11 show another example of mounting the extension rings not coaxially. Ring 421, 422 and 423 are not mounted on the same axis and might diverge in the angle of their axis. The outgoing rays (531) go to slightly different location. This assembly show that the individual images of the target deviate from one another stretching the target location to form a stretched shape (514).

These are just examples and many more deviations and techniques can be applied. One can also go to closer to theory implementation making a small treatment volume.

The main innovation of this invention is the longitudinal tiling of complete rings as tiled parts with ring extensions using planar tiles forming an extended structure, The designed possibility of deviation from the Rowland radius, the tilt angle and the off-cut angle. This can be done in more ways than the examples given.

Additional innovation is a structure that allows the adjustment of individual tiles.

1. An X-ray system for providing a converging X-rays comprising:
a. an X-ray source having an optical axis thereof; and
b. an X-ray lens arrangement comprising at least one first ring having a first Bragg reflecting surface formed by a plurality of tiles made from single crystal,
wherein said at least one ring is provided with at least one second ring mounted adjacently thereto along said optical axis in a coaxial manner; said second ring has a second Bragg reflecting surface reflecting surface thereof; said second reflecting surface is formed by a plurality of tiles made from single crystal such that Bragg angle at said second reflecting surface meets one of the following conditions:
a. said second reflecting surface is mounted within the Rowland circle envelope location.
b. said second reflecting surface is formed by tiles with an off-cut angle relative to crystallographic plane of said single crystal according to the Johansson and Johan theory where the reflecting surface is tangent to the Rowland radius R; and
c. crystallographic planes of said single crystals of said second reflecting surface are tiled relative to said optical axis according to the Johansson and Johan theory and the crystallographic planes are tangent to double Rowland radius 2R.

2. The X-ray system according to claim 1 wherein at least one of the said single crystal tiles of said first and second reflecting surfaces is threadly connected to said first and second rings threaded members, respectively; at least one of the said single crystal tiles is individually adjustable by means said threaded members; said treaded members are configured for one of the following:
a. Variation of a tilt angle;
b. Variation of a radial distance from a center of said ring by changing said distance from the location where the tiles are held on the ring.
c. Variation of the tile's roll, yaw and pitch relative to the optical axis by changing a combination of holding screws.

3. The X-ray system according to claim 1 wherein the lens system comprises of part of rings, complete rings, conical rings, barrel shaped rings and any combination thereof.

4. The X-ray system according to claim 1, wherein the said coaxial extension rings might deviate from the theoretical parameters of the Johann and Johansson theory for the controlling of the size and shape of the target by the following means:
a. Displacement of a central axis of said second ring apart from said optical axis;
b. tilt of said central axis of said second ring by a predetermined angle relative to said optical axis;
c. Displacement of said tiles away from the Rowland envelope location to a predetermined position in correspondence to a target size and shape.;
d. Angular Displacement of said tiles away from the Rowland envelope location to a predetermined position in correspondence to a target size and shape.;
e. Angular displacement of said tiles from Johansson-and-Johan geometry in correspondence to a target size and shape; and
f. Any combination of the above deviation methods.
